(19) United States
(12) Patent Application Publication
(10) Pub. No.: US 2006/0192423 A1
(43) Pub. Date: Aug. 31, 2006

(54) Axle assembly of driving wheel

(76) Inventors: Jae Myoung Song, Gyeonggi-do (KR); Hyung Joo Lee, Gyeongsangbuk-do (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,075

(22) Filed: Sep. 14, 2005

(30) Foreign Application Priority Data
Feb. 28, 2005 (KR) 10-2005-16533

(51) Int. Cl. B60B 27/00

(52) U.S. Cl. 301/105.1

(57) ABSTRACT

An axle assembly of a driving wheel of the present invention removes a hub and forms a brake disc integral type hub in order to integrate the hub and a brake disc. A protrusion portion is formed on an end of the brake disc integral type hub, and one portion of the protrusion portion is provided to be opposite to an inner race of a bearing, and a lower portion of the protrusion portion is provided to be opposite to a bearing inner race shaft. Since constructed such above, its structure is simple and its weight reduces. Also, since an assembly process is simple, and an assembly operation time becomes shortened, cost may be saved.

### BACKGROUND OF THE INVENTION

1. Field of Invention

The present invention relates to an axle assembly of a driving wheel, and more particularly, to an axle assembly of a driving wheel provided with a disc brake integral type hub in which a hub is removed and a wheel bearing is integrated with a brake disc.

2. Description of the Prior Art

Generally, an axle of a vehicle is a portion supporting the weight of the vehicle through a wheel attached thereto, and divided into a driving wheel axle delivering a driving force generated at an engine and a driven wheel axle not delivering the driving force.

Furthermore, according to a suspension manner, the axle of the vehicle is divided into an integral type axle combining left and right wheels with one axle and a separate type axle enabling the left and the right wheels to work respectively separately. The driving wheel axle serves to deliver a driving force passed through a transmission and a differential gear from an engine to wheels, and to support the strengths of up and down and left and right directions coming from the road surface, and the front and the rear directions. A front axle of a front-wheel driving vehicle or a rear axle of a rear-wheel driving vehicle corresponds thereto.

The axle is connected to a wheel through a hub, and an end portion of the hub is covered with a cover to prevent dust or foreign body from incoming and prevent an internal lubrication oil from leaking.

In the meantime, a disc brake of a vehicle is constructed to brake by pressing a brake pad with an oil pressure on both sides of a brake disc rotating with wheels. The disc brake comprises a brake disc made of special cast iron and rotating with being connected to a hub, a caliper made of special cast iron and shaped into a saddle, a couple of brake cylinders combined in the left and right sides of the caliper, a piston, and a pad mounted to the piston and generating a driving force by friction with the brake disc.

As illustrated in FIG. 1, a conventional axle assembly comprises a hub assembly 10, a brake disc 20, a wheel bearing assembly 30, and a knuckle 40.

The hub assembly 10 comprises a hub 12 and a hub bolt 14. The wheel bearing assembly 30 comprises a bearing 32, an inner race 34, an outer race 36, and a bearing connecting bolt 38.

A hub flange 16 of the hub assembly 10 is combined with the brake disc 20 and a wheel (not illustrated) to the outside of a vehicle by the hub bolt 14, and coupled with the wheel bearing assembly 30 to the inside of the vehicle, thereby being coupled with other suspension (not illustrated) parts, such as the knuckle 40.

While driving of the vehicle, wheels, the brake disc 20, and the hub 12 rotate, and the bearing 32 mounted to the fixed knuckle 40 serves to support the load of the vehicle and makes rotation smooth.

Meanwhile, the brake disc 20 is connected by using the hub bolt 14 to be fixed to the hub flange 16 of the hub 12. Also, said brake disc 20 and the brake disc 20 assembled to the knuckle 40 constitute brake apparatus of the vehicle, and serve to stop the vehicle by the friction resistance between a brake pad (not illustrated) and a disc (not illustrated).

Since the conventional axle assembly constructed such above processes the brake disc and a wheel loaded surface on a hub section, there is a disadvantage that cost goes up, assembly man-hours also increase and design freedom gets lowered.

Furthermore, since the management of the axial flow shake of the hub and the brake disc is required to secure the stable brake capacity, there is a problem that the management of general shake is difficult because of the shake accumulated between parts.

In addition, there is a disadvantage that the management of general shake is difficult since a tap hole process for assembly of the brake disc is added, and cost goes up since a process time increases due to addition of process man hours and assembly.

### SUMMARY OF THE INVENTION

The present invention is conceived to solve the above problems. Thus, an object of the present invention is to provide an axle assembly of a driving wheel provided with a brake disc integral type hub in which a hub of an axle assembly for vehicle is removed and a brake disc is integrated with a wheel bearing.

Other object of the present invention is to provide an axle assembly of a driving wheel which can simplify the structure of an axle assembly, thereby reducing its weight and saving its cost.

To accomplish the above object of the present invention, according to an aspect of the present invention, there is provided an axle assembly of a driving wheel comprising: a hub; a brake disc connected to the hub; a wheel bearing assembly comprising a bearing, an inner race and an outer race formed inside and outside of the bearing, and a bolt connecting the bearing to a knuckle; and a knuckle connected to the wheel bearing assembly; wherein a brake disc integral type hub is formed by removing a hub to integrate the brake disc and the hub, a protrude portion is formed on one end of the brake disc integral type hub, a portion of the protrude portion is provided to be opposite to the inner race of the bearing, and a lower portion of the protrude portion is provided to be opposite to a bearing inner race shaft.

The brake disc integral type hub is connected by a bolt by inserting a driving shaft and inserting a plane washer and a spring washer.

According to another aspect of the present invention, there is provided an axle assembly of a driving wheel comprising: a hub; a brake disc connected to the hub; a wheel bearing assembly comprising a bearing, an inner race and an outer race formed inside and outside of the bearing, and a bolt connecting the bearing to a knuckle; and a knuckle connected to the wheel bearing assembly; wherein a hub is removed to integrate the brake disc and the hub, the wheel bearing assembly further comprises a bearing inner race shaft, and a portion of the bearing inner race shaft is combined with a brake disc integral type hub by forming.

In the axle assembly, it is preferable that a caulking portion is formed on an end of the bearing inner race shaft. Also, the caulking portion contacts with a spring washer when one portion of the caulking portion is connected to a driving shaft, and is further fastened by a bolt to be elastically supported. The forming is completed by forming or swaging.

Further, an inter-contacting portion of the brake disc integral type hub is processed to be any one of non-circle, a polygon, and a spline, so as to prevent inter-skidding.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a sectional view of an assembly of a brake disc and a wheel bearing according to the prior art;

FIG. 2 is a sectional view of an axle assembly of a driving wheel according to an embodiment of the present invention;

FIG. 3 is a front sectional view of the axle assembly of FIG. 2; and

FIG. 4 is a sectional view of an assembly of a driving wheel according to other embodiment of the present invention.

### DETAILED DESCRIPTION OF THE PREFERRED EMBODIMENT

An embodiment of an axle assembly of a driving wheel of the present invention will be in detail described with reference to the accompanying drawings.

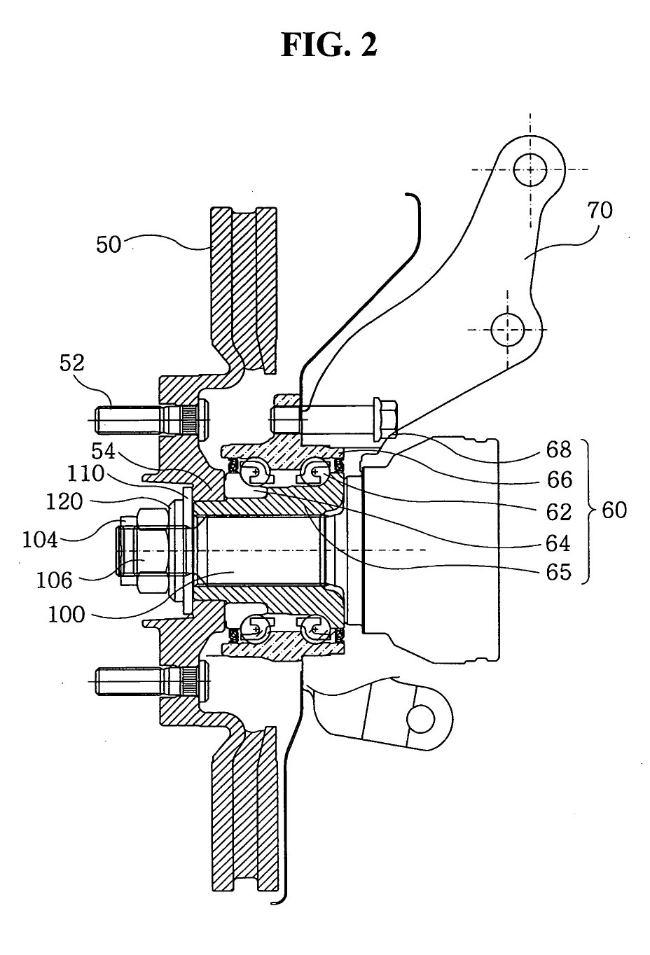

FIG. 2 is a sectional view of an axle assembly of a driving wheel according to an embodiment of the present invention. As illustrated in FIG. 2, the axle assembly of the driving wheel of the present invention comprises a brake disc integral type hub 50, a wheel bearing assembly 60, and a knuckle 70.

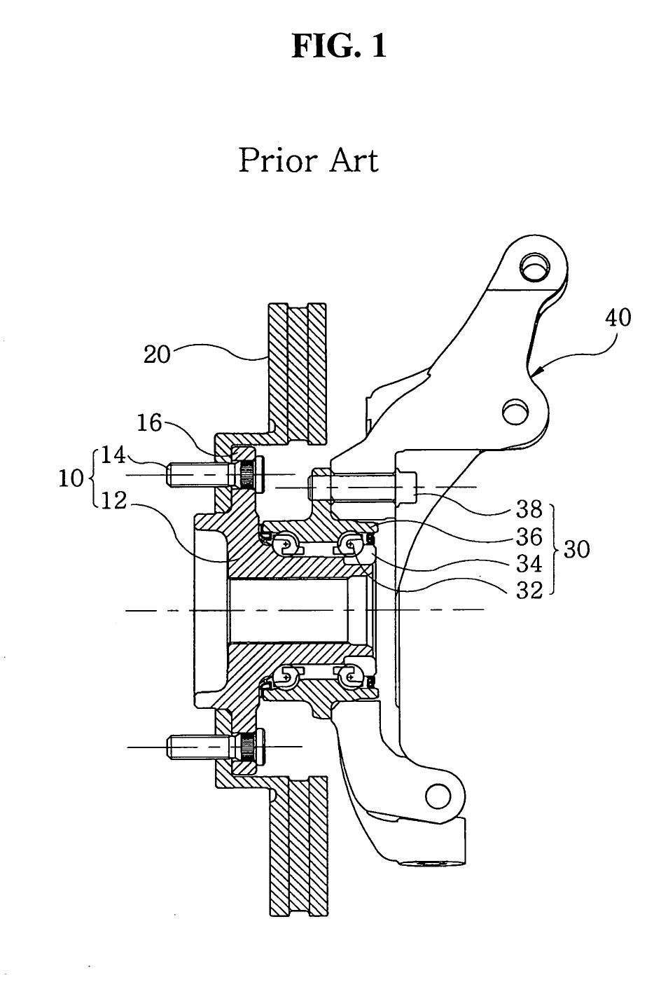

The wheel bearing assembly 60 is comprises a bearing 62, an inner race 64, a bearing inner race shaft 65, an outer race 66, and a bearing connecting bolt 68. The brake disc integral type hub 50 integrates a conventional brake disc 20 (see FIG. 1) and a portion of a hub 12. A protrude portion 54 is formed on one end of the brake disc integral type hub 50. One portion of the protrude portion 54 is provided to be opposite to an inner race 64, and a lower portion of the protrude portion 54 is provided to be opposite to the bearing inner race shaft 65. In FIG. 2, a reference symbol 52 is a hub bolt.

A screw (not illustrated) formed nut 104 is provided on one end of a driving shaft 100. A plane washer 110 and a spring washer 120 are inserted into a portion where the nut 104 is formed, to closely combine the bearing inner race shaft with the protrude portion 54, and connected by the bolt 106.

An axle assembly of a driving wheel constructed such above connects the wheel bearing assembly 60 to the knuckle 70 by the bearing connecting bolt 68. The driving shaft 100 is inserted in a state where a protrusion portion of the brake disc integral type hub 50 is opposite to the inner race 64, and the plane washer 110 and the spring washer 120 are inserted. The spring washer 120 is inserted in a state where the plane washer 110 supports one end of the brake disc integral type hub 50, and connected by the bolt 106.

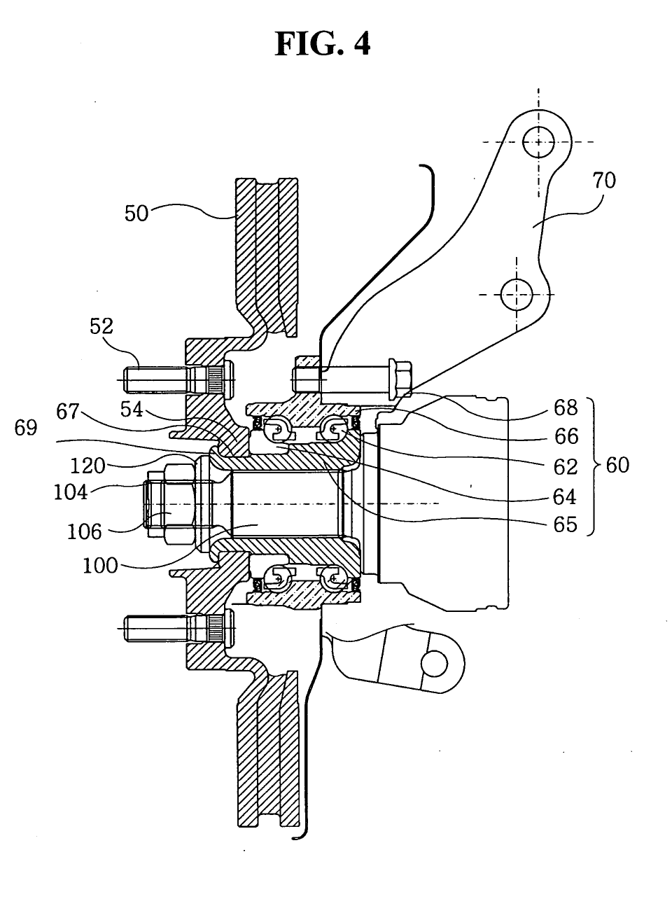

FIG. 4 is a sectional view of an axle assembly of a driving wheel according to other embodiment of the present invention.

In the axle assembly of the driving wheel according to other embodiment of the present invention, the wheel bearing assembly 60 comprises the bearing 62, the inner race 64, the bearing inner race shaft 65, the outer race 66, and the bearing connecting bolt 68.

The difference between the aforementioned and the present embodiments is that a recessed portion 67 is formed on one end of the bearing inner race shaft 65, and the protrude portion 54 of the brake disc integral type hub 50 is inserted into the recessed portion 67. A caulking portion 69 is formed on one portion of the bearing inner race shaft 65. The reference symbol 52 is a hub bolt.

At this time, the protrude portion 54 of the brake disc integral type hub 50 is inserted into the recessed portion 67 of the bearing inner race shaft 65, and later connected by forming or swaging. Like above, when the brake disc integral type hub 50 is applied, a vehicle axle assembly becomes simplified. Thereby, not only the number of parts but also weight and cost may be reduced.

When one portion of the caulking portion 69 is connected to the driving shaft 100, it contacts with the spring washer 120 and is further fastened by the bolt 106 of the driving shaft 100 to be elastically supported. At this time, the bolt 106 of the driving shaft 100 is coupled with the nut 104 formed on one end of the driving shaft 100.

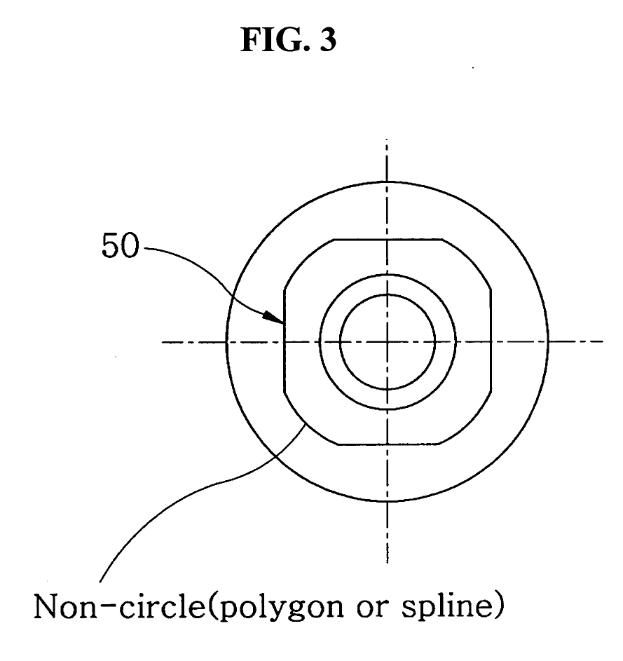

As illustrated in FIG. 3, a portion of the brake disc integral type hub 50 contacting with the wheel bearing assembly 60 each other is processed to be any one of non-circle, a polygon, and a spline, so as to prevent inter-skidding in the direction of the circumference of a circle with the wheel bearing assembly 60. After being processed to be any one of non-circle, a polygon, and a spline, the brake disc integral type hub 50 is coupled with the bearing inner race shaft 65 by giving a shaft force of an axial flow to the bearing 62 and giving pre-pressure thereof.

As described above, since an axle assembly of a driving wheel of the present invention removes a hub and integrates a wheel bearing and a brake disc, its structure becomes simplified and its weight also reduces. In addition, an assembly operation time gets shortened and cost may be saved since an assembly process becomes simplified.

Furthermore, since the axle assembly of the driving wheel of the present invention enhances design freedom of a wheel bearing assembly, its durability life span may increase. Also, since it is possible to manage the axial flow shake of the axle assembly easily, the brake capacity may be secured.

What is claimed is:

1. An axle assembly of a driving wheel comprising:
a hub;
a brake disc connected to the hub;
a wheel bearing assembly comprising a bearing, an inner race and an outer race formed inside and outside of the bearing, and a bolt connecting the bearing to a knuckle; and
a knuckle connected to the wheel bearing assembly;
wherein a brake disc integral type hub is formed by removing a hub to integrate the brake disc and the hub, a protrude portion is formed on one end of the brake disc integral type hub, a portion of the protrude portion is provided to be opposite to the inner race of the bearing, and a lower portion of the protrude portion is provided to be opposite to a bearing inner race shaft.

2. The axle assembly of claim 1, wherein the brake disc integral type hub is connected by a bolt by inserting a driving shaft and inserting a plane washer and a spring washer.

3. An axle assembly of a driving wheel comprising:
a hub;
a brake disc connected to the hub;
a wheel bearing assembly comprising a bearing, an inner race and an outer race formed inside and outside of the bearing, and a bolt connecting the bearing to a knuckle; and
a knuckle connected to the wheel bearing assembly;
wherein a hub is removed to integrate the brake disc and the hub, the wheel bearing assembly further comprises a bearing inner race shaft, and a portion of the bearing inner race shaft is combined with a brake disc integral type hub by forming.

4. The axle assembly of claim 3, wherein a caulking portion is formed on an end of the bearing inner race shaft.

5. The axle assembly of claim 4, wherein the caulking portion contacts with a spring washer when one portion of the caulking portion is connected to a driving shaft, and is further fastened by a bolt to be elastically supported.

6. The axle assembly of claim 3, wherein the forming is completed by forming or swaging.

7. The axle assembly of claim 3, wherein an inter-contacting portion of the brake disc integral type hub is processed to be any one of non-circle, a polygon, and a spline, so as to prevent inter-skidding.
